(19) United States
(12) Patent Application Publication
(10) Pub. No.: US 2026/0050787 A1
(43) Pub. Date: Feb. 19, 2026

(54) DEVICE AND METHOD FOR RECONFIGURING ARTIFICIAL NEURAL NETWORK TOPOLOGY ROBUST AGAINST CYBER ATTACKS

(71) Applicant: Dongguk University Industry-Academic Cooperation Foundation, Seoul (KR)

(72) Inventors: Insoo SOHN, Seoul (KR); Sara KAVIANI, Seoul (KR); Samaneh SHAMSHIRI, Seoul (KR)

(73) Assignee: Dongguk University Industry-Academic Cooperation Foundation, Seoul (KR)

(21) Appl. No.: 19/101,761

(22) PCT Filed: Aug. 9, 2023
(86) PCT No.: PCT/KR2023/095039

§ 371 Date: Feb. 6, 2025

(30) Foreign Application Priority Data
Aug. 24, 2022 (KR) 10-2022-0106092

(51) Int. Cl. G06N 3/082; G06F 21/50

(52) U.S. Cl. CPC G06N 3/082; G06F 21/50; G06F 2221/033

(57) ABSTRACT

The present invention relates to device and method for reconfiguring artificial neural network topology robust against cyber attacks. According to one embodiment of the present invention, the device comprising an input layer, a plurality of hidden layers, and an output layer, may include: a pruning unit configured to determine at least one target neuron for pruning from the plurality of hidden layers and remove links connecting the determined target neuron and neurons associated with the determined target neuron, and a link reconfiguration unit configured to implement additional link connections among neurons constituting the input layer, the plurality of hidden layers, and the output layer to reinforce the connections removed by the pruning and reconfigure the artificial neural network topology into a scale-free structure.

### TECHNICAL FIELD

The present invention relates to device and method for reconfiguring artificial neural network topology robust against cyber attacks, and more specifically, to a technology for optimizing the artificial neural network topology into a robust structure against adversarial cyber attacks by reconfiguring the artificial neural network topology through pruning techniques and the implementation of a scale-free topology.

### RELATED ART

Recently, the demand for intelligentization and automation of existing systems using artificial intelligence (AI) technology has been increasing.

In particular, research on implementing intelligent systems that analyze usage patterns of existing systems based on AI and autonomously execute optimal performance according to various situations is actively being conducted in fields such as the Internet of Things (IoT), autonomous vehicles, wearable medical systems, and defense weapon systems.

In other words, an Artificial Neural Network (ANN) refers to a computational architecture modeled after the biological brain.

With the recent advancements in neural network technology, studies utilizing neural network devices to analyze input data and extract meaningful information in various types of electronic systems have been actively conducted.

However, as the amount of training data for neural networks increases, the connectivity within the artificial neural network becomes more complex. Although accuracy improves concerning past training data, the reliability of predictions for new data decreases due to overfitting and connectivity complexity issues, making it challenging to defend against cyber attacks.

In particular, cyber attacks targeting AI-based intelligent modules, the core of intelligent systems, have also been increasing, drawing significant attention to creating robust neural networks capable of withstanding adversarial attacks.

Backdoor attacks, which induce targeted misclassification without affecting the accuracy on clean data, are among the most efficient forms of attack.

Such attacks may cause errors in the output for data input into the artificial neural network.

For example, an attacker could insert a malicious dataset into widely used open-source neural network modules for autonomous driving to increase speed when stopping, thus compromising the artificial neural network's integrity.

However, there is a lack of research addressing adversarial attacks aimed at degrading the performance or gaining control over AI-based intelligent modules.

As a complementary solution, techniques such as neuron pruning or link pruning in neural networks have been considered.

However, pruning techniques have the drawback of reducing the accuracy of data learning within the artificial neural network.

### DETAILED DESCRIPTION

### Technical Subject

An objective of example embodiments is to provide device and method for reconfiguring the artificial neural network topology to optimize it into a robust structure against adversarial cyber attacks by utilizing pruning techniques and the implementation of a scale-free topology.

An objective of example embodiments is to reconstruct the artificial neural network topology into a robust structure against cyber attacks before such attacks occur. This is achieved by using training data, which is part of a clean dataset, to identify dormant and active links within the artificial neural network and preemptively removing dormant neurons and links that are vulnerable to adversarial cyber attacks through pruning techniques.

An objective of example embodiments is to address performance degradation caused by weakened connectivity structures in neural networks due to neuron and link pruning. By implementing additional link connections to achieve a scale-free topology, the artificial neural network topology is reconfigured into a scale-free structure, thereby optimizing the artificial neural network for robustness against cyber attacks.

### Solution

According to an example embodiment, device for reconfiguring an artificial neural network topology is provided. The device is configured to reconfigure the artificial neural network topology, the artificial neural network comprising an input layer, a plurality of hidden layers, and an output layer. The device includes: a pruning unit, configured to determine at least one neuron to be pruned from the plurality of hidden layers and to remove links connecting the determined at least one pruned neuron and neurons connected to the determined at least one pruned neuron, and a link reconfiguration unit, configured to implement additional link connections between neurons constituting the input layer, the plurality of hidden layers, and the output layer to reinforce the connections removed by the pruned links, thereby reconfiguring the artificial neural network topology into a scale-free structure.

The pruning unit may be configured to check, for each of the plurality of hidden layers, whether at least one neuron responds to training data based on training results output through the output layer after the training data is input through the input layer and processed through the plurality of hidden layers, and to determine neurons that do not respond to the training data as the at least one neuron to be pruned.

The training data may include an image recognition dataset, wherein the image recognition dataset comprises at least one backdoor trigger pixel associated with a cyber attack, and the at least one backdoor trigger pixel may be used to control the at least one neuron to be pruned and the links connected to the at least one neuron to be pruned.

The link reconfiguration unit may be configured to implement additional link connections from at least one neuron constituting the input layer to neurons constituting the plurality of hidden layers and the output layer, excluding link connections between neurons constituting the input layer, in the artificial neural network topology after the links connected to the at least one neuron to be pruned and the neurons connected to the at least one neuron to be pruned have been removed, thereby reconfiguring the artificial neural network topology into a scale-free structure.

The link reconfiguration unit may be configured to calculate the degree of connectivity of neurons constituting the input layer, the plurality of hidden layers, and the output layer in the artificial neural network topology after the links connected to the at least one neuron to be pruned and the neurons connected to the at least one neuron to be pruned have been removed. The link reconfiguration unit may further add link connections to selected neurons based on the calculated degree of connectivity and verify whether the addition of link connections has been completed up to the output layer, thereby implementing the additional link connections and reconfiguring the artificial neural network topology into a scale-free structure.

The link reconfiguration unit may be configured to determine an L-th layer among the plurality of hidden layers in the artificial neural network topology after the links connected to the at least one neuron to be pruned and the neurons connected to the at least one neuron to be pruned have been removed. The link reconfiguration unit may further calculate the degree of connectivity for each neuron in the L-th layer based on the connections between the L-th layer and the (L−1)-th layer, connect one or more neurons in the L-th layer to each neuron from the first neuron to the last neuron in the (L+1)-th layer based on the calculated degree of connectivity, calculate the degree of connectivity for each neuron in the (L+1)-th layer based on the connections with the L-th layer, and connect one or more neurons in the (L+1)-th layer to each neuron from the first neuron to the last neuron in the (L+2)-th layer based on the calculated degree of connectivity. This process may be repeated up to the output layer, thereby implementing the additional link connections and reconfiguring the artificial neural network topology into a scale-free structure.

The L-th layer may serve as a reference layer for implementing the additional link connections among the plurality of hidden layers in the artificial neural network topology after the links connected to the at least one neuron to be pruned and the neurons connected to the at least one neuron to be pruned have been removed. The (L−1)-th layer may be a layer located prior to the reference layer, the (L+1)-th layer may be a layer located subsequent to the reference layer, and the (L+2)-th layer may be a layer located subsequent to the (L+1)-th layer.

The link reconfiguration unit may be configured to implement additional link connections in the artificial neural network topology, starting from the next hidden layer after the first hidden layer among the plurality of hidden layers and continuing to the output layer, based on the artificial neural network topology after the links connected to the at least one neuron to be pruned and the neurons connected to the at least one neuron to be pruned have been removed. This process may reconfigure the artificial neural network topology into a scale-free structure.

The link reconfiguration unit may be configured to reconfigure the artificial neural network topology into a scale-free structure based on a combination of link connections, including SRSF (Short-Range Scale-Free) link connections, LRSF (Long-Range Scale-Free) link connections, and FC (Fully Connected) link connections.

According to an example embodiment of the present invention, the device for reconfiguring an artificial neural network topology may further include an artificial neural network construction unit configured to determine the number of the plurality of hidden layers between the input layer and the output layer with respect to the artificial neural network topology, and to construct the artificial neural network topology by connecting neurons constituting the input layer, the plurality of hidden layers, and the output layer with links.

According to an example embodiment of the present invention, a method for reconfiguring the artificial neural network topology, the artificial neural network comprising an input layer, a plurality of hidden layers, and an output layer, may include: determining, by a pruning unit, at least one neuron to be pruned from the plurality of hidden layers and removing links connecting the determined at least one neuron to be pruned and neurons connected to the determined at least one neuron to be pruned, and implementing, by a link reconfiguration unit, additional link connections between neurons constituting the input layer, the plurality of hidden layers, and the output layer to reinforce the connections removed by the pruned links, thereby reconfiguring the artificial neural network topology into a scale-free structure.

The step of determining at least one neuron to be pruned from the plurality of hidden layers may include: checking, for each of the plurality of hidden layers, whether at least one neuron responds to the training data, based on training results output through the output layer after the training data is input through the input layer and processed through the plurality of hidden layers, and determining neurons that do not respond to the training data as the at least one neuron to be pruned.

The step of implementing additional link connections between neurons constituting the input layer, the plurality of hidden layers, and the output layer to reinforce the connections removed by the pruned links, thereby reconfiguring the artificial neural network topology into a scale-free structure, may include: implementing additional link connections from at least one neuron constituting the input layer to neurons constituting the plurality of hidden layers and the output layer, excluding link connections between neurons constituting the input layer, in the artificial neural network topology after the links connected to the at least one neuron to be pruned and the neurons connected to the at least one neuron to be pruned have been removed. This process may reconfigure the artificial neural network topology into a scale-free structure.

The step of implementing additional link connections between neurons constituting the input layer, the plurality of hidden layers, and the output layer to reinforce the connections removed by the pruned links, thereby reconfiguring the artificial neural network topology into a scale-free structure, may include: calculating the degree of connectivity of the neurons constituting the input layer, the plurality of hidden layers, and the output layer in the artificial neural network topology after the links connected to the at least one neuron to be pruned and the neurons connected to the at least one neuron to be pruned have been removed, adding link connections to selected neurons based on the calculated degree of connectivity, and verifying whether the addition of link connections has been completed up to the output layer, thereby implementing the additional link connections and reconfiguring the artificial neural network topology into a scale-free structure.

The step of implementing additional link connections between neurons constituting the input layer, the plurality of hidden layers, and the output layer to reinforce the connections removed by the pruned links, thereby reconfiguring the artificial neural network topology into a scale-free structure, may include: determining an L-th layer among the plurality of hidden layers in the artificial neural network topology after the links connected to the at least one neuron to be pruned and the neurons connected to the at least one neuron to be pruned have been removed, calculating the degree of connectivity for each neuron in the L-th layer based on the connections between the L-th layer and the (L−1)-th layer, and connecting one or more neurons in the L-th layer to each neuron from the first neuron to the last neuron in the (L+1)-th layer based on the calculated degree of connectivity, calculating the degree of connectivity for each neuron in the (L+1)-th layer based on the connections with the L-th layer, and connecting one or more neurons in the (L+1)-th layer to each neuron from the first neuron to the last neuron in the (L+2)-th layer based on the calculated degree of connectivity, and repeating the process up to the output layer, thereby implementing the additional link connections and reconfiguring the artificial neural network topology into a scale-free structure.

The L-th layer may serve as a reference layer for implementing the additional link connections among the plurality of hidden layers in the artificial neural network topology after the links connected to the at least one neuron to be pruned and the neurons connected to the at least one neuron to be pruned have been removed. The (L−1)-th layer may be a layer located prior to the reference layer, the (L+1)-th layer may be a layer located subsequent to the reference layer, and the (L+2)-th layer may be a layer located subsequent to the (L+1)-th layer.

### Effect

According to an example embodiment, device for reconfiguring an artificial neural network topology and method are provided. The device and method are configured to optimize the artificial neural network topology into a robust structure against adversarial cyber attacks by utilizing pruning techniques and the implementation of a scale-free topology.

According to an example embodiment, the invention identifies dormant and active links within the artificial neural network using training data that is part of a clean dataset. By preemptively removing dormant neurons and links vulnerable to adversarial cyber attacks through pruning techniques, the artificial neural network may be reconfigured into a robust structure before being subjected to cyber attacks.

According to an example embodiment, the invention addresses performance degradation caused by weakened connectivity structures within the artificial neural network. By implementing additional link connections to achieve a scale-free topology, the artificial neural network topology is reconfigured into a scale-free structure, thereby optimizing it to be robust against cyber attacks.

### BRIEF DESCRIPTION OF DRAWINGS

FIG. 1 is a diagram illustrating device for reconfiguring artificial neural network topology according to an example embodiment of the present invention.

FIG. 2 is a diagram illustrating the operation of the pruning unit of the device for reconfiguring an artificial neural network topology according to an example embodiment of the present invention.

FIG. 3 is a diagram illustrating the operation of the link reconfiguration unit of the device for reconfiguring an artificial neural network topology according to an example embodiment of the present invention.

FIG. 4 is a diagram illustrating various neural network topologys according to an example embodiment of the present invention.

FIG. 5 is a diagram illustrating various training datasets for testing the reconfigured neural network topology according to an example embodiment of the present invention.

FIGS. 6A to 11B are diagrams illustrating the performance evaluation of the reconfigured neural network topology according to an example embodiment of the present invention.

FIGS. 12 and 13 are diagrams illustrating a method for reconfiguring an artificial neural network topology according to an example embodiment of the present invention.

### BEST MODE

Hereafter, various embodiments of the present document are described with reference to the accompanying drawings.

The embodiments and the terms used therein are not intended to limit the technology described herein to specific forms of implementation but should be understood to include various modifications, equivalents, and/or substitutions thereof.

In describing the various embodiments below, detailed explanations of related known functions or configurations may be omitted if it is determined that they unnecessarily obscure the essence of the invention.

The terms used hereinafter are defined based on the functions in the various embodiments, and these definitions may vary depending on the user's, operator's intent, or customary usage. Therefore, the definitions should be interpreted based on the entirety of the present specification.

In relation to the description of the drawings, similar reference numerals may be used for similar components.

Unless explicitly stated otherwise, singular expressions may include plural meanings.

In this document, expressions such as “A or B” or “at least one of A and/or B” may include all possible combinations of the listed items.

Expressions such as “first,” “second,” “primary,” or “secondary” may modify corresponding components regardless of their order or importance and are used only to distinguish one component from another, not to limit those components.

When it is stated that a (e.g., first) component is “connected to” or “coupled to” another (e.g., second) component (functionally or communicatively), the component may be directly connected to the other component or connected through another component (e.g., a third component).

The term “configured to” may interchangeably mean, depending on the context, “adapted for,” “capable of,” “modified to,” “designed to,” or “able to,” whether in hardware or software.

In some contexts, the expression “a device configured to” may mean that the device may perform a certain function in conjunction with other devices or components.

For example, the phrase “a processor configured to perform A, B, and C” may refer to a dedicated processor (e.g., an embedded processor) for performing the operations, or a general-purpose processor (e.g., a CPU or application processor) capable of performing the operations by executing one or more software programs stored in a memory device.

Additionally, the term “or” should be interpreted as an inclusive logical “or” rather than an exclusive logical “or.”

Unless otherwise stated or explicitly indicated by the context, the phrase “x uses a or b” means any one of the natural inclusive permutations thereof.

The terms such as “ . . . unit” or “ . . . module” used hereinafter refer to a unit that processes at least one function or operation and may be implemented as hardware, software, or a combination of hardware and software.

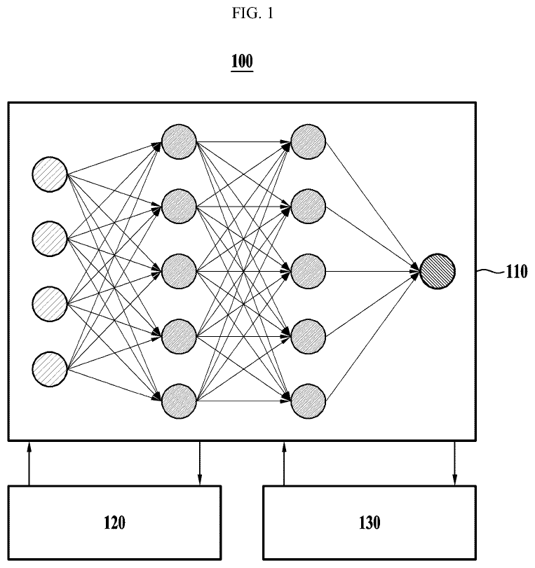

FIG. 1 is a diagram illustrating a device for reconfiguring an artificial neural network topology according to an example embodiment of the present invention.

FIG. 1 illustrates the components of the device for reconfiguring the artificial neural network topology according to an example embodiment of the present invention.

Referring to FIG. 1, the device for reconfiguring the artificial neural network topology 100 according to an example embodiment of the present invention is a device for reconfiguring the artificial neural network topology comprising an input layer, a plurality of hidden layers, and an output layer. The device includes a pruning unit 120 and a link reconfiguration unit 130 and may further include an artificial neural network construction unit 110.

For example, the artificial neural network construction unit 110 may be configured to determine the number of the plurality of hidden layers between the input layer and the output layer with respect to the artificial neural network topology and to construct the artificial neural network topology by connecting neurons constituting the input layer, the plurality of hidden layers, and the output layer with links.

Additionally, the artificial neural network construction unit 110 may be configured to construct the artificial neural network topology by receiving data related to artificial neural networks designed to analyze usage patterns of existing systems based on artificial intelligence in fields such as the Internet of Things (IoT), autonomous vehicles, wearable medical systems, and defense weapon systems, and to autonomously execute optimal performance according to various situations. The received data may be used to optimize the artificial neural network topology.

For example, an artificial neural network may consist of multiple layers, where input data is received at a single input layer, processed through a varying number of hidden layers, and finally produces an output value via an output layer.

Additionally, the artificial neural network contains multiple neurons in its various layers, which are connected by links. These links acquire weight values during the training process.

In one example, the device for reconfiguring the artificial neural network topology 100 may implement a robust artificial neural network topology resistant to cyber attacks by reconfiguring the connection artificial neural network topology through the collaboration of the pruning unit 120 and the link reconfiguration unit 130.

According to an example embodiment of the present invention, the pruning unit 120 may selectively remove specific neurons and links from the connections between neurons constituting the input layer, the plurality of hidden layers, and the output layer of the artificial neural network.

For example, the pruning unit 120 may determine at least one neuron to be pruned from the plurality of hidden layers and remove links connected to the determined at least one neuron to be pruned and the determined at least one neuron connected to the pruned neuron.

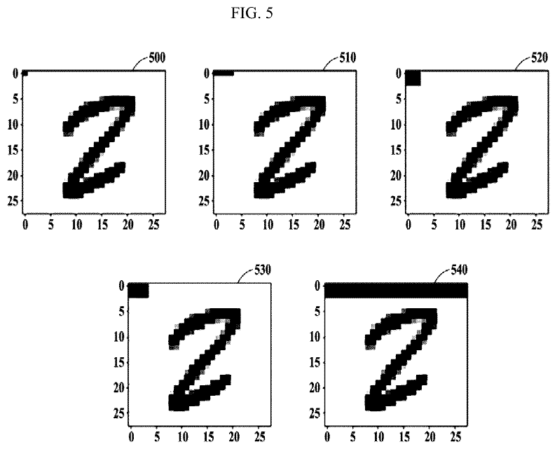

According to an example embodiment of the present invention, the pruning unit 120 may check, for each of the plurality of hidden layers, whether at least one neuron responds to the training data input through the input layer and output through the output layer after passing through the plurality of hidden layers, based on training results with respect to the training data. Neurons that do not respond to the training data may be determined as at least one neuron to be pruned. Examples of training data used for this purpose are further explained with reference to FIG. 5.

For example, the pruning unit 120 may protect the artificial neural network from cyber attacks by preemptively identifying and removing neurons that do not respond to training data that may be a target of cyber attacks, as well as the links constructed by such neurons, prior to a cyber attack.

According to an example embodiment of the present invention, the link reconfiguration unit 130 may implement additional link connections between neurons constituting the input layer, the plurality of hidden layers, and the output layer to reinforce connections removed by the pruned links, thereby reconfiguring the artificial neural network topology into a scale-free structure.

Thus, the present invention enables the reconfiguration of the artificial neural network topology using pruning techniques and the implementation of a scale-free topology, thereby optimizing the artificial neural network into a robust structure resistant to adversarial cyber attacks.

For example, the link reconfiguration unit 130 may implement additional link connections from at least one neuron constituting the input layer to neurons constituting the plurality of hidden layers and the output layer, excluding link connections between neurons constituting the input layer, in the artificial neural network topology after the links connected to at least one neuron to be pruned and neurons connected to the pruned neuron have been removed. This process may reconfigure the artificial neural network topology into a scale-free structure.

According to an example embodiment of the present invention, the link reconfiguration unit 130 may calculate the degree of connectivity of neurons constituting the input layer, the plurality of hidden layers, and the output layer in the artificial neural network topology after the links connected to at least one neuron to be pruned and neurons connected to the pruned neuron have been removed. Based on the calculated degree of connectivity, the link reconfiguration unit may add link connections to selected neurons and verify whether the addition of link connections has been completed up to the output layer. By implementing these additional link connections, the artificial neural network topology may be reconfigured into a scale-free structure.

For example, the link reconfiguration unit 130 may reconfigure the artificial neural network topology into a scale-free structure based on a combination of link connections, including SRSF (Short-Range Scale-Free) link connections, LRSF (Long-Range Scale-Free) link connections, and FC (Fully Connected) link connections.

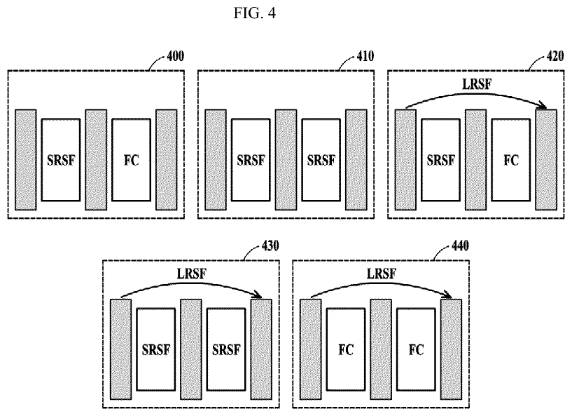

The artificial neural network topology based on the combination of SRSF link connections, LRSF link connections, and FC link connections is further explained with reference to FIG. 4.

According to an example embodiment of the present invention, the device for reconfiguring the artificial neural network topology 100 may optimize the artificial neural network topology by reconfiguring it into a robust structure resistant to adversarial cyber attacks, which are a critical threat to the intelligent module. Through this optimization, the device may minimize performance degradation of the intelligent system caused by cyber attacks.

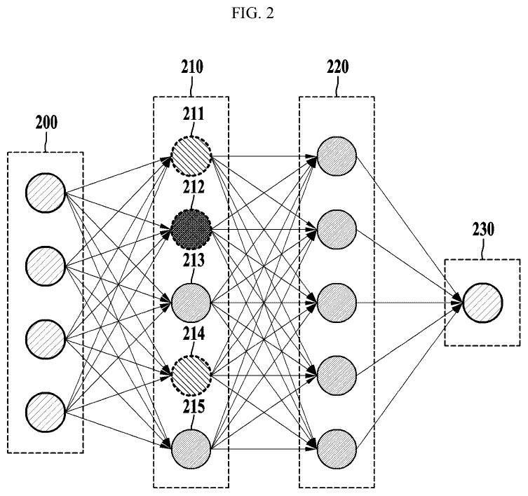

FIG. 2 is a diagram illustrating the operation of the pruning unit of the device for reconfiguring an artificial neural network topology according to an example embodiment of the present invention.

FIG. 2 exemplifies the operation of the pruning unit, which selectively identifies and removes neurons and links that may be targets of attacks through pruning to reconfigure the artificial neural network topology, according to an example embodiment of the present invention.

Referring to FIG. 2, the pruning unit according to an example embodiment of the present invention performs pruning on an artificial neural network comprising an input layer 200, a first hidden layer 210, a second hidden layer 220, and an output layer 230.

The neurons constituting the input layer 200, the first hidden layer 210, the second hidden layer 220, and the output layer 230 are connected through links.

Training datasets are input through the input layer 200, and output values are produced as training results through the output layer 230 after passing through the first hidden layer 210 and the second hidden layer 220.

According to an example embodiment of the present invention, the pruning unit reconfigures the artificial neural network topology by pruning the first hidden layer 210.

In the first hidden layer 210, neurons 213 and 215 are retained, while the neurons 211, 212, and 214, indicated by dashed lines, are deleted by pruning.

At this time, the pruning unit also deletes the links connected to neurons 211, 212, and 214.

Specifically, neuron 212, which is deleted through pruning, is a neuron infected by a cyber attack.

The neurons 211, 212, and 214, which are pruned along with their related links, are neurons and links that show little to no response to the training data used to configure the artificial neural network.

Neurons and links that do not respond to training data are more susceptible to being controlled and infected by attackers.

Accordingly, the device for reconfiguring the artificial neural network topology may determine pruning targets and proactively remove them to defend against external cyber attacks in advance.

According to an example embodiment of the present invention, the device for reconfiguring the artificial neural network topology must enhance the performance of the artificial neural network by compensating for the artificial neural network topology after removing at least one pruned neuron and its connected links.

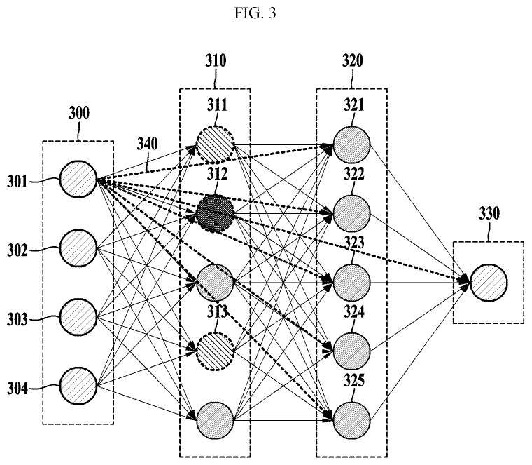

Thus, as shown in FIG. 3, the device for reconfiguring the artificial neural network topology may preserve or enhance the performance of the reconfigured artificial neural network through the link reconfiguration unit.

Therefore, the present invention enables the identification of dormant and active links within the artificial neural network using training data that is part of a clean dataset. By preemptively removing dormant neurons and links that are susceptible to adversarial cyber attacks through pruning techniques, the artificial neural network may be reconfigured into a robust structure resistant to cyber attacks before such attacks occur.

FIG. 3 is a diagram illustrating the operation of the link reconfiguration unit of the device for reconfiguring the artificial neural network topology according to an example embodiment of the present invention.

FIG. 3 exemplifies the configuration in which the link reconfiguration unit, according to an example embodiment of the present invention, implements additional link connections in an artificial neural network topology where certain neurons and links have been removed, thereby reconfiguring the connection artificial neural network topology.

Referring to FIG. 3, the link reconfiguration unit according to an example embodiment of the present invention adds link connections to an artificial neural network comprising an input layer 300, a first hidden layer 310, a second hidden layer 320, and an output layer 330, thereby reconfiguring the artificial neural network topology into a scale-free structure.

The input layer includes neurons 301, 302, 303, and 304, while the first hidden layer 310 has neurons 311, 312, and 313 removed, leaving only the remaining neurons. The second hidden layer 320 includes neurons 321, 322, 323, 324, and 325, and the output layer 330 consists of a single neuron.

As neurons 311, 312, and 313 are removed, the corresponding links are also removed, weakening the link connections from the input layer 300 to the second hidden layer 320 and the output layer 330.

For example, the artificial neural network topology in FIG. 3 may represent the artificial neural network topology after the links connected to at least one pruned neuron and at least one neuron to be pruned have been removed.

As an example, the link reconfiguration unit adds additional links 340 to compensate for the removed links by implementing new link connections between the neurons in the input layer 300 and the first hidden layer 310, where neurons 311, 312, and 313 have been pruned.

For example, the link reconfiguration unit establishes additional direct links 340 from neuron 301 in the input layer 300 to neurons 321, 322, 323, 324, and 325 in the second hidden layer 320 and also connects directly to the neuron in the output layer 330.

According to an example embodiment of the present invention, the link reconfiguration unit may connect additional links 340 between neuron 301 and neuron 321, neuron 301 and neuron 322, neuron 301 and neuron 323, neuron 301 and neuron 324, and neuron 301 and neuron 325.

Additionally, the link reconfiguration unit may also establish additional links 340 that directly connect neuron 301 and the neuron in the output layer 330.

The link reconfiguration unit may connect additional links 340 to neurons 302, 303, and 304 in the input layer 300 in the same manner as the additional link connections established for neuron 301.

Furthermore, the link reconfiguration unit may implement similar additional link connections for the remaining neurons in the first hidden layer 310 if additional hidden layers are present, extending the additional link connections up to the output layer 330.

According to an example embodiment of the present invention, the link reconfiguration unit may determine an L-th layer among the plurality of hidden layers in the artificial neural network topology after the links connected to at least one pruned neuron and at least one neuron to be pruned have been removed.

For example, the L-th layer may correspond to the first hidden layer 310, and the connected neurons may be the remaining neurons. The link reconfiguration unit may calculate the degree of connectivity for each neuron in the L-th layer based on the connections between the L-th layer and the (L−1)-th layer, and connect one or more neurons in the L-th layer to each neuron from the first to the last neuron in the (L+1)-th layer based on the calculated degree of connectivity.

Additionally, the link reconfiguration unit may calculate the degree of connectivity for each neuron in the (L+1)-th layer based on the connections with the L-th layer, and connect one or more neurons in the (L+1)-th layer to each neuron from the first to the last neuron in the (L+2)-th layer based on the calculated degree of connectivity. This process may be repeated up to the output layer, thereby implementing additional link connections and reconfiguring the artificial neural network topology into a scale-free structure.

For example, the L-th layer may serve as a reference layer for implementing additional link connections in the artificial neural network topology after the links connected to at least one pruned neuron and at least one neuron to be pruned have been removed.

The (L−1)-th layer may be the layer preceding the reference layer, the (L+1)-th layer may be the layer following the reference layer, and the (L+2)-th layer may be the layer following the (L+1)-th layer.

For example, if the reference layer, the L-th layer, is the first hidden layer 310, then the (L−1)-th layer is the input layer 300, the (L+1)-th layer is the second hidden layer 320, and the (L+2)-th layer is the output layer 330.

According to an example embodiment of the present invention, the link reconfiguration unit may implement additional link connections 340 from the input layer 300, excluding the first hidden layer 310, to the next hidden layer 320, and extending up to the output layer 330, thereby reconfiguring the artificial neural network topology into a scale-free structure.

Furthermore, the link reconfiguration unit may repeatedly implement additional link connections until the output layer 330 becomes the L-th layer.

In other words, the link reconfiguration unit may compensate for structural defects caused by the removed neurons and links due to pruning by implementing additional link connections, thereby preventing performance degradation in the artificial neural network.

Therefore, the present invention addresses performance degradation caused by weakened connectivity in the artificial neural network through neuron and link pruning and implements additional link connections to reconfigure the structure into a scale-free structure, optimizing the artificial neural network into a robust structure resistant to cyber attacks.

FIG. 4 is a diagram illustrating various artificial neural network topologys according to an example embodiment of the present invention.

FIG. 4 illustrates the artificial neural network topology reconfigured into a scale-free structure by the link reconfiguration unit based on a combination of SRSF (Short-Range Scale-Free) link connections, LRSF (Long-Range Scale-Free) link connections, and FC (Fully Connected) link connections according to an embodiment of the present invention.

Referring to FIG. 4, models 400 through 440 include input and output layers positioned at the ends, with hidden layers located between them.

The input, hidden, and output layers are interconnected by a combination of SRSF, LRSF, and FC link connections, forming the connectivity artificial neural network topology.

Model 400 connects the neurons in the input layer to the first hidden layer using the SRSF method, while all other inter-layer connections follow a fully connected (FC) structure similar to traditional neural networks.

Model 400 does not include any LRSF connections between the input layer and other layers.

Model 410 employs SRSF connections between the input layer, hidden layers, and output layer without any LRSF connections between the input layer and other layers. Consequently, Model 410 does not have fully connected layers.

Model 420 integrates the structures of Model 410 and LRSF connections.

Specifically, the input layer connects to the first hidden layer using the SRSF method, while the other layers are fully connected.

Additionally, Model 420 includes a small number of LRSF connections between the input layer and other layers.

Model 430 combines the structure of Model 410 and LRSF connections.

All inter-layer connections follow the SRSF method, while some LRSF connections are present between the input layer and other layers.

Model 440 lacks sequential layers connected by SRSF but features full connections between all layers. It also includes LRSF connections between the input layer and other layers.

The combination of Models 400 and 440 forms Model 420, and the combination of Models 410 and 440 forms Model 430.

The connectivity of an artificial neural network topology reconfigured by the artificial neural network reconfiguration device of the present invention may correspond to Models 420 and 430.

In summary, the artificial neural network reconfiguration device may reconstruct the connectivity structure of an artificial neural network into a cyber attack-resistant structure by implementing additional links for dormant links and neurons pruned based on pruning criteria, thereby creating a robust and scale-free network configuration.

FIG. 5 is a diagram illustrating various training datasets used to test the reconfigured artificial neural network topology according to an embodiment of the present invention.

FIG. 5 illustrates various training datasets used to test the reconfigured artificial neural network topology according to an embodiment of the present invention.

As shown in FIG. 5, Dataset 500 includes a training dataset with one pixel trigger, Dataset 510 includes a training dataset with four pixel triggers, Dataset 520 includes a training dataset with nine pixel triggers, Dataset 530 includes a training dataset with twelve pixel triggers, and Dataset 540 includes a training dataset with eighty-four pixel triggers.

Here, the pixel triggers correspond to the bar images at the top of each of Dataset 500 through Dataset 540.

Pixel triggers are corrupted data included in the clean dataset and are used to assess the accuracy and attack success rate (ASR) of the datasets.

For example, the training data includes an image recognition dataset that comprises at least one backdoor trigger pixel associated with a cyber attack.

These backdoor trigger pixels may control at least one neuron to be pruned and the links connected to the neurons to be pruned.

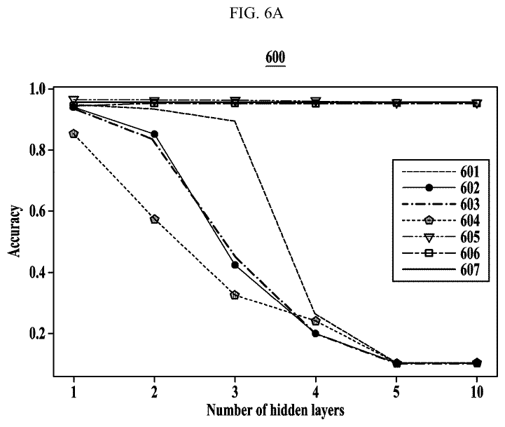

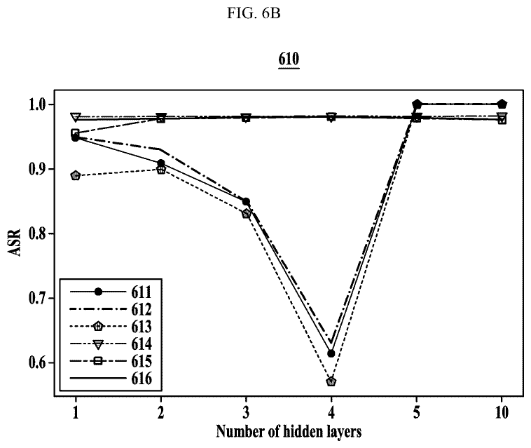

In other words, pixel triggers, as backdoor trigger pixels within Dataset 500 through Dataset 540, are used for adversarial attacks on the artificial neural network. These pixel triggers serve as simulated attackers to evaluate the performance of the artificial neural network and to select neurons and links for pruning, as demonstrated in FIGS. 6A through 11B.

FIGS. 6A through 11D are diagrams explaining the performance evaluation of the reconfigured artificial neural network topology according to an embodiment of the present invention.

FIGS. 6A and 6B describe the performance evaluation of the reconfigured neural network connectivity using accuracy and attack success rate metrics based on the training datasets described in FIG. 5. These evaluations are conducted on Models 1 through 5, illustrated in FIG. 4, and a conventional model (fully connected feedforward neural network, FC-FFNN).

The graph 600 in FIG. 6A illustrates the learning accuracy, while the graph 610 in FIG. 6B illustrates the attack success rate.

Referring to the graph 600 in FIG. 6A, indicator line 601 represents the accuracy of the FC-FFNN trained with the clean dataset, indicator line 602 represents the accuracy of the FC-FFNN trained with the training dataset, indicator line 603 represents the accuracy of Model 1 trained with the training dataset, indicator line 604 represents the accuracy of Model 2 trained with the training dataset, indicator line 605 represents the accuracy of Model 3 trained with the training dataset, indicator line 606 represents the accuracy of Model 4 trained with the training dataset, and indicator line 607 represents the accuracy of Model 5 trained with the training dataset.

A comparison of indicator lines 601 and 602 reveals a decrease in accuracy, while indicator lines 605 and 606 demonstrate relatively superior accuracy.

Referring to the graph in FIG. 6B (610), indicator line 611 represents the attack success rate of the FC-FFNN trained with the training dataset, indicator line 612 represents the attack success rate of Model 1 trained with the training dataset, indicator line 613 represents the attack success rate of Model 2 trained with the training dataset, indicator line 614 represents the attack success rate of Model 3 trained with the training dataset, indicator line 615 represents the attack success rate of Model 4 trained with the training dataset, and indicator line 616 represents the attack success rate of Model 5 trained with the training dataset.

According to the graphs 600, 610 in FIGS. 6A and 6B, Models 3 and 4 demonstrate excellent link connectivity, achieving high accuracy on the clean dataset and a high attack success rate on corrupted training datasets.

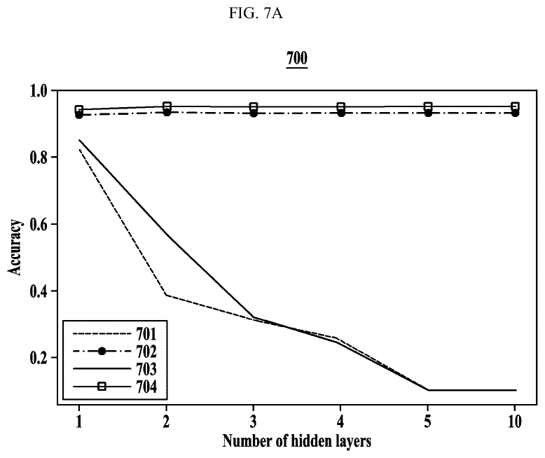

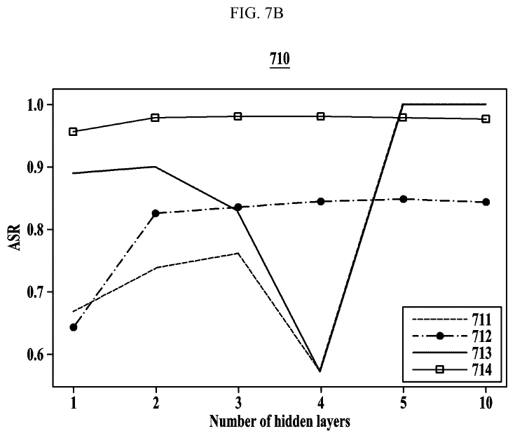

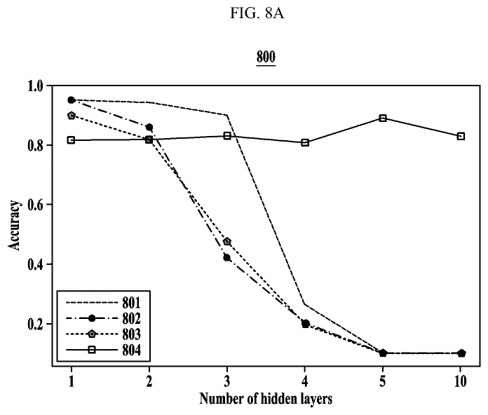

FIGS. 7A and 7B illustrate the performance evaluation of the reconfiguration of the artificial neural network topology based on the accuracy and attack success rate, achieved by training Model 2 410 and Model 4 430, as illustrated in FIG. 4, using Dataset 500 and Dataset 520 from the training datasets described in FIG. 5.

Graph 700 in FIG. 7A illustrates the learning accuracy, while graph 710 in FIG. 7B illustrates the attack success rate, both used to compare the performance of SRSF and LRSF structures.

Referring to graph 700 in FIG. 7A, indicator line 701 represents the accuracy of Model 2 trained with Dataset 1, indicator line 702 represents the accuracy of Model 4 trained with Dataset 1, indicator line 703 represents the accuracy of Model 2 trained with Dataset 3, and indicator line 704 represents the accuracy of Model 4 trained with Dataset 3.

Referring to graph 710 in FIG. 7B, indicator line 711 represents the attack success rate of Model 2 trained with Dataset 1, indicator line 712 represents the attack success rate of Model 4 trained with Dataset 1, indicator line 713 represents the attack success rate of Model 2 trained with Dataset 3, and indicator line 714 represents the attack success rate of Model 4 trained with Dataset 3.

Based on graphs 700 and 710, it may be observed that Model 4 demonstrates higher accuracy on clean data and a higher attack success rate compared to Model 2.

Additionally, the attack success rate varies with the number of hidden layers, which may help determine the appropriate number of hidden layers.

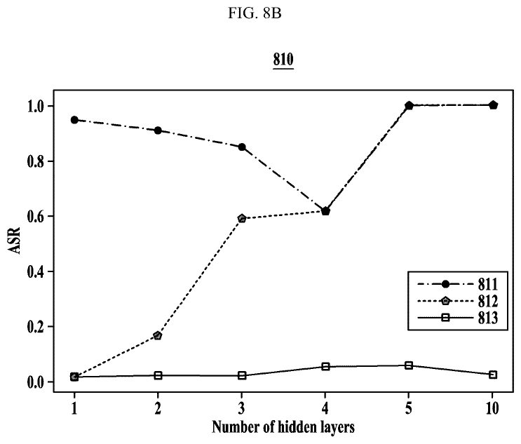

FIGS. 8A through 10D illustrate the performance evaluation of the reconfigured neural network topology by analyzing accuracy and attack success rates on various malicious datasets after applying link and neuron pruning according to an embodiment of the present invention.

FIGS. 8A and 8B present the learning accuracy and attack success rate of a conventional FC-FFNN on clean data, the learning accuracy and attack success rate of the conventional FC-FFNN on malicious data, the learning accuracy and attack success rate of the conventional FC-FFNN after applying link pruning (LP) on malicious data, and the learning accuracy of the conventional FC-FFNN after applying both link pruning (LP) and scale-freeness (SF) implementation on malicious data.

Regarding the graphs in FIGS. 8A and 8B, the malicious data corresponds to the FMNIST dataset.

Referring to graph 800 in FIG. 8A, with respect to accuracy as the number of hidden layers varies, indicator line 801 represents the learning results of the FC-FFNN on clean data, indicator line 802 represents the learning results of the FC-FFNN on malicious data, indicator line 803 represents the learning results of the FC-FFNN on malicious data after applying LP, and indicator line 804 represents the learning results of the FC-FFNN on malicious data after applying LPSF (link pruning with scale-freeness).

Referring to graph 810 in FIG. 8B, with respect to the attack success rate as the number of hidden layers varies, indicator line 811 represents the learning results of the FC-FFNN on malicious data, indicator line 812 represents the learning results of the FC-FFNN on malicious data after applying LP, and indicator line 813 represents the learning results of the FC-FFNN on malicious data after applying LPSF.

Based on graphs 800 and 810, it may be observed that the LPSF method, corresponding to the method for reconfiguring artificial neural network topology of the present invention, achieves higher accuracy and lower attack success rates against malicious data.

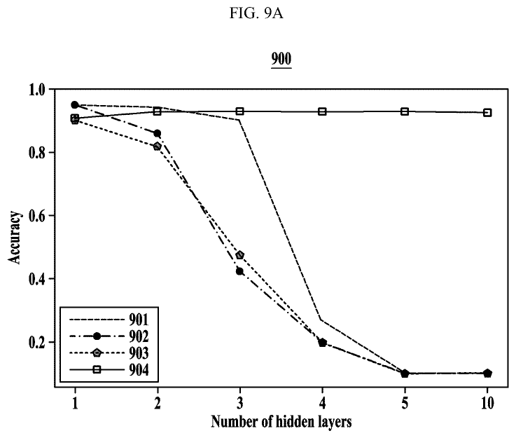

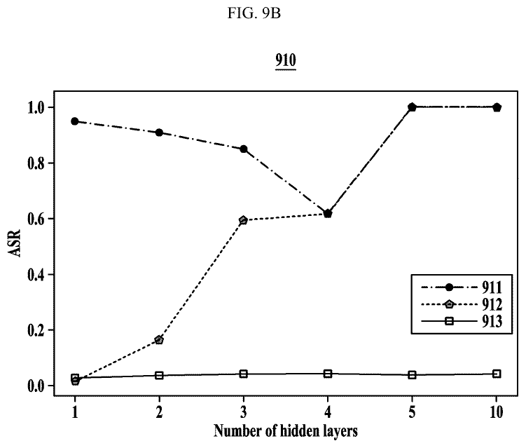

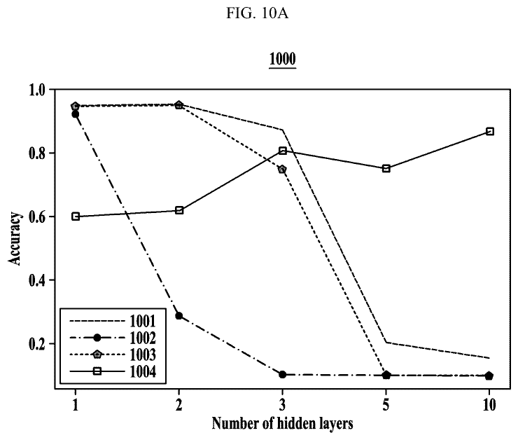

FIGS. 9A and 9B illustrate the learning accuracy and attack success rate of a conventional FC-FFNN on clean data, the learning accuracy and attack success rate of the conventional FC-FFNN on malicious data, the learning accuracy and attack success rate of the conventional FC-FFNN after applying link pruning (LP) on malicious data, and the learning accuracy of the conventional FC-FFNN after applying both link pruning (LP) and scale-freeness (SF) implementation on malicious data.

Regarding the graphs in FIGS. 9A and 9B, the malicious data corresponds to the MNIST dataset.

Referring to graph 900 in FIG. 9A, with respect to accuracy as the number of hidden layers varies, indicator line 901 represents the learning results of the FC-FFNN on clean data, indicator line 902 represents the learning results of the FC-FFNN on malicious data, indicator line 903 represents the learning results of the FC-FFNN on malicious data after applying LP, and indicator line 904 represents the learning results of the FC-FFNN on malicious data after applying LPSF (link pruning with scale-freeness).

Referring to graph 910 in FIG. 9B, with respect to the attack success rate as the number of hidden layers varies, indicator line 911 represents the learning results of the FC-FFNN on malicious data, indicator line 912 represents the learning results of the FC-FFNN on malicious data after applying LP, and indicator line 913 represents the learning results of the FC-FFNN on malicious data after applying LPSF.

Based on graphs 900 and 910, it may be observed that the LPSF method, corresponding to the method for reconfiguring artificial neural network topology of the present invention, achieves higher accuracy and lower attack success rates against malicious data.

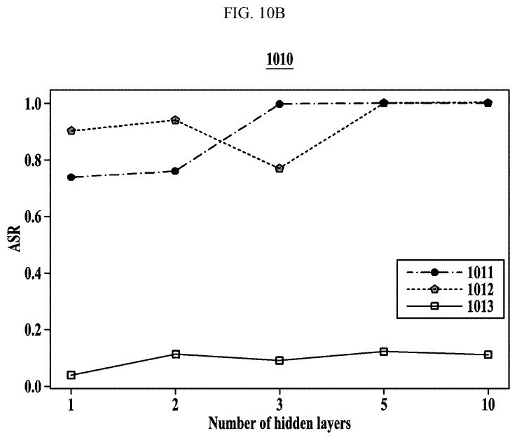

FIGS. 10A and 10B illustrate the learning accuracy and attack success rate of a conventional FC-FFNN on clean data, the learning accuracy and attack success rate of the conventional FC-FFNN on malicious data, the learning accuracy and attack success rate of the conventional FC-FFNN after applying link pruning (LP) on malicious data, and the learning accuracy of the conventional FC-FFNN after applying both link pruning (LP) and scale-freeness (SF) implementation on malicious data.

Regarding the graphs in FIGS. 10A and 10B, the malicious data corresponds to the HODA dataset.

Referring to graph 1000 in FIG. 10A, with respect to accuracy as the number of hidden layers varies, indicator line 1001 represents the learning results of the FC-FFNN on clean data, indicator line 1002 represents the learning results of the FC-FFNN on malicious data, indicator line 1003 represents the learning results of the FC-FFNN on malicious data after applying LP, and indicator line 1004 represents the learning results of the FC-FFNN on malicious data after applying LPSF (link pruning with scale-freeness).

Referring to graph 1010 in FIG. 10B, with respect to the attack success rate as the number of hidden layers varies, indicator line 1011 represents the learning results of the FC-FFNN on malicious data, indicator line 1012 represents the learning results of the FC-FFNN on malicious data after applying LP, and indicator line 1013 represents the learning results of the FC-FFNN on malicious data after applying LPSF.

Based on graphs 1000 and 1010, it may be observed that the LPSF method, corresponding to the method for reconfiguring artificial neural network topology of the present invention, achieves higher accuracy and lower attack success rates against malicious data.

In other words, as shown in the graphs from FIGS. 8A to 10B, the LP method has a performance flaw that reduces the accuracy of the dataset, and as the number of hidden layers increases, the attack success rate from malicious data also increases. However, the LPSF method not only achieves higher accuracy for the dataset but also prevents an increase in the attack success rate from malicious data, even as the number of hidden layers increases. This enables the reconfiguration of the artificial neural network topology into one that is robust against cyber attacks.

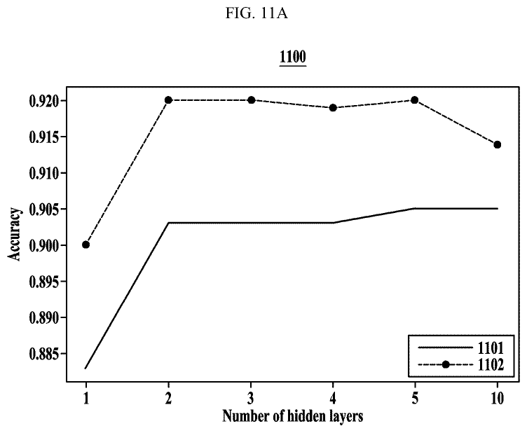

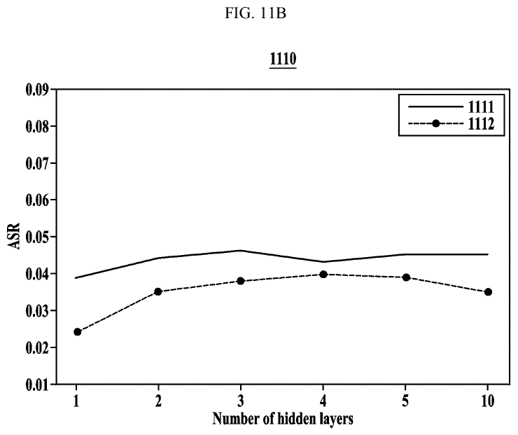

FIGS. 11A and 11B illustrate the performance evaluation of the reconfigured neural network topology according to an embodiment of the present invention, using Dataset 1 and Dataset 3 as described in FIG. 5.

Graph 1100 in FIG. 11A represents learning accuracy, while graph 1110 in FIG. 11B represents attack success rate.

Referring to graph 1100 in FIG. 11A, indicator line 1101 represents the accuracy based on the learning results with Dataset 1, and indicator line 1102 represents the accuracy based on the learning results with Dataset 3.

Referring to graph 1110 in FIG. 11B, indicator line 1111 represents the attack success rate for Dataset 1, and indicator line 1112 represents the attack success rate for Dataset 3.

Indicator line 1101 shows lower accuracy compared to indicator line 1102, and indicator line 1111 shows a higher attack success rate compared to indicator line 1112.

This indicates that the device for reconfiguring the artificial neural network topology and method according to an embodiment of the present invention are more suitable for defending against larger-scale attacks.

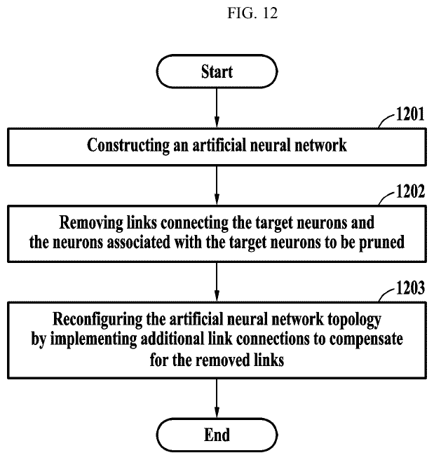

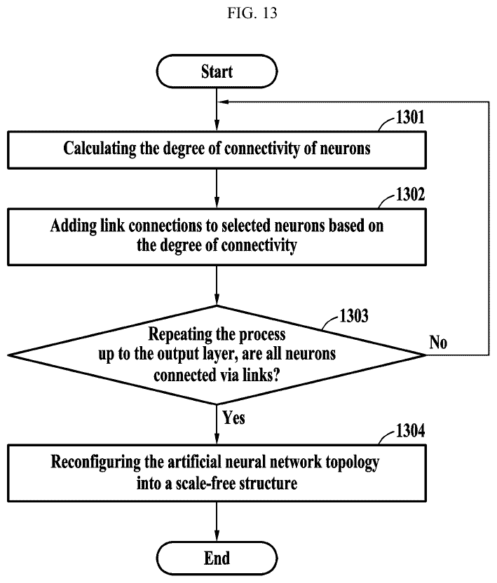

FIGS. 12 and 13 are diagrams illustrating the method for reconfiguring the artificial neural network topology according to an embodiment of the present invention.

FIG. 12 illustrates the procedure for reconfiguring the connection structure of an artificial neural network into a cyber attack-resistant structure using the reconfiguration method according to an embodiment of the present invention.

Referring to FIG. 12, in step 1201, the method for reconfiguring the artificial neural network according to an embodiment of the present invention constructs an artificial neural network.

Specifically, the method determines the number of hidden layers between the input and output layers, and connects the neurons constituting the input layer, hidden layers, and output layer via links to construct the artificial neural network topology.

For example, the artificial neural network topology may be built by downloading or loading a previously constructed neural network topology for optimization purposes.

In step 1202, the method for reconfiguring the artificial neural network according to an embodiment of the present invention removes the pruned neurons and the links connected to them.

In other words, the method for reconfiguring artificial neural network topology according to an embodiment of the present invention may determine at least one pruned neuron among multiple hidden layers and remove the links connected to the determined pruned neuron and at least one other pruned neuron.

In step 1203, the method for reconfiguring the artificial neural network topology by implementing additional link connections to reinforce the connections removed.

Specifically, the method adds additional links between the neurons constituting the input layer, hidden layers, and output layer, reconfiguring the structure into a scale-free structure to compensate for the removed links.

FIG. 13 illustrates the procedure for reconfiguring the connection artificial neural network topology into a scale-free structure to enhance resistance against cyber attacks.

Referring to FIG. 13, in step 1301, the method calculates the degree of connectivity of the neurons.

Specifically, it identifies an L-th layer among the hidden layers after pruning the neurons and links and calculates the degree of connectivity of neurons based on the connections between the L-th layer and the L−1 layer.

In step 1302, the method adds links to selected neurons based on the calculated degree of connectivity.

The method for reconfiguring artificial neural network topology according to an embodiment of the present invention connects each neuron in the L+1 layer, from the first neuron to the last neuron, to any neuron in the L layer based on the calculated degree of connectivity.

For example, the degree of connectivity is related to the number of links connected to a neuron. Neurons with a higher number of links are identified as high-performance neurons and are prioritized for additional link connections.

In step 1303, the method for reconfiguring artificial neural network topology according to an embodiment of the present invention repeats steps 1301 and 1302 until it verifies whether all neurons are connected with links up to the output layer.

Specifically, the method calculates the degree of connectivity for each neuron in the L+1 layer based on its connections with the L layer, and then connects the neurons in the L+2 layer, from the first neuron to the last neuron, to any neuron in the L+1 layer based on the calculated degree of connectivity. This process is repeated until all neurons are connected with links up to the output layer.

If all neurons are connected with links, the method proceeds to step 1304. If not, it returns to step 1301.

In step 1304, the method for reconfiguring artificial neural network topology according to an embodiment of the present invention reconfigures the artificial neural network topology into a scale-free structure based on steps 1301 through 1303.

In other words, the method compensates for performance-degraded areas within the artificial neural network topology caused by pruning by reconstructing them into a scale-free structure.

The devices described above may be implemented as hardware components, software components, and/or a combination of hardware and software components. For example, the devices and components described in the embodiments may be implemented using one or more general-purpose computers or special-purpose computers, such as a processor, controller, arithmetic logic unit (ALU), digital signal processor (DSP), microcomputer, field-programmable array (FPA), programmable logic unit (PLU), microprocessor, or any other device capable of executing and responding to instructions.

The processing device may execute an operating system (OS) and one or more software applications running on the operating system. Additionally, the processing device may access, store, manipulate, process, and generate data in response to the execution of software. For convenience of understanding, a single processing device is described in some instances. However, one skilled in the art will recognize that the processing device may include multiple processing elements and/or multiple types of processing elements. For example, the processing device may include multiple processors or a combination of one processor and one controller. Other processing configurations, such as parallel processors, are also possible.

Software may include a computer program, code, instructions, or any combination thereof and may configure the processing device to perform desired operations or command the processing device independently or collectively. Software and/or data may be permanently or temporarily embodied in any type of machine, component, physical device, virtual equipment, computer storage medium or device, or transmitted signal wave for interpretation or use by the processing device to provide commands or data. Software may also be distributed across networked computer systems and stored or executed in a distributed manner. Software and data may be stored on one or more computer-readable recording media.

While the embodiments have been described with reference to specific figures, those skilled in the art will appreciate that various modifications and variations are possible based on the above descriptions. For example, the described techniques may be performed in a sequence different from that described, and/or the components of the described systems, structures, devices, circuits, etc., may be combined or configured differently, or replaced or substituted with other components or equivalents, while still achieving the intended results.

Therefore, other implementations, embodiments, and equivalents of the claims are also within the scope of the claims provided below.

What is claimed is:

1. A device for reconfiguring an artificial neural network topology comprising an input layer, a plurality of hidden layers, and an output layer, the device comprising:
A pruning unit configured to determine at least one neuron to be pruned from the plurality of hidden layers and configure to remove links connecting the determined at least one pruned neuron and at least one neuron connected to the determined at least one pruned neuron; and
A link reconfiguration unit configured to configure additional link connections between neurons of the input layer, the plurality of hidden layers, and the output layer to reinforce connections removed by the pruned links, thereby reconfiguring the artificial neural network topology into a scale-free structure.

2. The device of claim 1, wherein the pruning unit is configured to determine, for each of the plurality of hidden layers, whether the at least one neuron responds to training data input through the input layer and output through the output layer after passing through the plurality of hidden layers, based on training results with respect to the training data, and to determine neurons that do not respond to the training data as the at least one neuron to be pruned.

3. The device of claim 2, wherein the training data includes an image recognition dataset, and the image recognition dataset comprises at least one backdoor trigger pixel associated with a cyber attack, and wherein the at least one backdoor trigger pixel is used to control the links connected to the at least one pruned neuron and the at least one pruned neuron.

4. The device of claim 1, wherein the link reconfiguration unit is configured to implement the additional link connections from at least one neuron constituting the input layer to neurons constituting the plurality of hidden layers and the output layer, excluding the link connections between at least one neuron constituting the input layer after the links connecting the at least one pruned neuron and the at least one neuron connected to the at least one pruned neuron have been removed in the artificial neural network topology, thereby reconfiguring the artificial neural network topology into the scale-free structure.

5. The device of claim 1, wherein the link reconfiguration unit is configured to:
calculate degree of connectivity of neurons constituting the input layer, the plurality of hidden layers, and the output layer, respectively, in the artificial neural network topology after links connecting the at least one pruned neuron and neurons connected to the at least one pruned neuron have been removed;
add link connections to a selected neuron based on the calculated degree of connectivity; and
verify whether the addition of link connections has been repeated up to the output layer,
wherein the additional link connections are implemented to reconfigure the artificial neural network topology into the scale-free structure.

6. The device of claim 1, wherein the link reconfiguration unit is configured to:
determine an L-th layer among the plurality of hidden layers in the artificial neural network topology after links connecting at least one pruned neuron and neurons connected to at least one pruned neuron have been removed;
calculate the degree of connectivity for each neuron in the L-th layer based on the connections between the L-th layer and the (L−1)-th layer;
connect at least one neuron of the L-th layer to each neuron from the first neuron to the last neuron in the (L+1)-th layer based on the calculated degree of connectivity;
calculate the degree of connectivity for each neuron in the (L+1)-th layer based on the connections with the L-th layer;
connect at least one neuron of the (L+1)-th layer to each neuron from the first neuron to the last neuron in the (L+2)-th layer based on the calculated degree of connectivity;
and repeat aforementioned process up to the output layer to implement additional link connections, thereby reconfiguring the artificial neural network topology into the scale-free structure.

7. The device of claim 6, wherein the L-th layer serves as a reference layer for implementing the additional link connections among the plurality of hidden layers in the artificial neural network topology after links connecting at least one pruned neuron and neurons connected to at least one pruned neuron have been removed;
the (L−1)-th layer is a layer located prior to the reference layer;
the (L+1)-th layer is a layer located subsequent to the reference layer; and
the (L+2)-th layer is a layer located subsequent to the (L+1)-th layer.

8. The device of claim 1, wherein the link reconfiguration unit is configured to reconstruct the artificial neural network topology into the scale-free structure by implementing the additional link connections in the artificial neural network topology, after the links connected to the at least one pruned neuron and the at least one pruned neuron have been removed, starting from the next hidden layer, excluding the first hidden layer among the plurality of hidden layers, from the input layer to the output layer.

9. The device of claim 1, wherein the link reconfiguration unit is configured to reconstruct the artificial neural network topology into the scale-free structure based on a combination of link connections, including SRSF (Short-Range Scale-Free) link connections, LRSF (Long-Range Scale-Free) link connections, and FC (Fully Connected) link connections.

10. The device of claim 1, further comprising:
an artificial neural network construction unit configured to determine a number of the plurality of hidden layers between the input layer and the output layer with respect to the artificial neural network topology, and to construct the artificial neural network topology by connecting neurons constituting the input layer, the plurality of hidden layers, and the output layer with links.

11. A method for reconfiguring an artificial neural network topology comprising an input layer, a plurality of hidden layers, and an output layer, the method comprising:
determining, by a pruning unit, at least one neuron to be pruned from the plurality of hidden layers and removing links connecting the determined at least one pruned neuron and at least one neuron connected to the determined at least one pruned neuron; and
implementing, by a link reconfiguration unit, additional link connections between neurons constituting the input layer, the plurality of hidden layers, and the output layer to reinforce the connections removed by the pruned links, thereby reconfiguring the artificial neural network topology into a scale-free structure.

12. The method of claim 11, wherein the step of determining at least one neuron to be pruned from the plurality of hidden layers comprises:
checking, for each of the plurality of hidden layers, whether at least one neuron responds to training data, based on training results output through the output layer after the training data is input through the input layer and processed through the plurality of hidden layers; and
determining neurons that do not respond to the training data as the at least one neuron to be pruned.

13. The method of claim 11, wherein the step of reconfiguring the artificial neural network topology into a scale-free structure by implementing additional link connections between neurons constituting the input layer, the plurality of hidden layers, and the output layer to reinforce the connections removed by the pruned links comprises:
implementing additional link connections from at least one neuron constituting the input layer to neurons constituting the plurality of hidden layers and the output layer, excluding link connections between neurons constituting the input layer, in the artificial neural network topology after the links connected to the at least one pruned neuron and the neurons connected to the at least one pruned neuron have been removed.

14. The method of claim 11, wherein the step of reconfiguring the artificial neural network topology into a scale-free structure by implementing additional link connections between neurons constituting the input layer, the plurality of hidden layers, and the output layer to reinforce the connections removed by the pruned links comprises:
calculating the degree of connectivity of the neurons constituting the input layer, the plurality of hidden layers, and the output layer in the artificial neural network topology after the links connected to the at least one pruned neuron and the neurons connected to the at least one pruned neuron have been removed;
adding link connections to selected neurons based on the calculated degree of connectivity; and
verifying whether the addition of link connections has been completed up to the output layer, thereby implementing the additional link connections and reconfiguring the artificial neural network topology into a scale-free structure.

15. The method of claim 11, wherein the step of reconfiguring the artificial neural network topology into a scale-free structure by implementing additional link connections between neurons constituting the input layer, the plurality of hidden layers, and the output layer to reinforce the connections removed by the pruned links comprises:
determining an L-th layer among the plurality of hidden layers in the artificial neural network topology after the links connected to the at least one pruned neuron and the neurons connected to the at least one pruned neuron have been removed;
calculating the degree of connectivity of each neuron in the L-th layer based on the connections between the L-th layer and the (L−1)-th layer, and connecting one or more neurons in the L-th layer to each neuron from the first to the last neuron in the (L+1)-th layer based on the calculated degree of connectivity; and
calculating the degree of connectivity of each neuron in the (L+1)-th layer based on the connections between the (L+1)-th layer and the L-th layer, and connecting one or more neurons in the (L+1)-th layer to each neuron from the first to the last neuron in the (L+2)-th layer based on the calculated degree of connectivity, and repeating the process up to the output layer, thereby implementing the additional link connections and reconfiguring the artificial neural network topology into a scale-free structure.

16. The method of claim 15, wherein the L-th layer is a reference layer for implementing the additional link connections among the plurality of hidden layers in the artificial neural network topology after the links connected to the at least one pruned neuron and the neurons connected to the at least one pruned neuron have been removed;
the (L−1)-th layer is a layer located prior to the reference layer;
the (L+1)-th layer is a layer located subsequent to the reference layer; and
the (L+2)-th layer is a layer located subsequent to the (L+1)-th layer.
